(19) United States
(12) Patent Application Publication
(10) Pub. No.: US 2026/0089161 A1
(43) Pub. Date: Mar. 26, 2026

(54) CONTROL APPARATUS AND CONTROL METHOD

(71) Applicant: Panasonic Automotive Systems Co., Ltd., Kanagawa (JP)

(72) Inventors: Jun ANZAI, Kanagawa (JP); Takumaru NAGAI, Osaka (JP); Akihito TAKEUCHI, Osaka (JP); Yuishi TORISAKI, Osaka (JP); Ryo HIRANO, Osaka (JP)

(73) Assignee: Panasonic Automotive Systems Co., Ltd., Kanagawa (JP)

(21) Appl. No.: 19/297,291

(22) Filed: Aug. 12, 2025

(30) Foreign Application Priority Data
Sep. 24, 2024 (JP) 2024-165014

(51) Int. Cl. H04L 9/40; H04L 67/12; H04W 4/48

(52) U.S. Cl. CPC H04L 63/10; H04L 63/083; H04L 63/20; H04L 67/12; H04W 4/48

(57) ABSTRACT

A control apparatus is provided in a vehicle system logically divided into a plurality of partitions. The control apparatus includes: a semantic kernel (SK) that controls, based on a static policy, communication access between two partitions 64 among a plurality of partitions; a policy decision point (PDP) that controls the communication access between the two partitions based on a dynamic policy, and a policy enforcement point (PEP) that controls the communication access between the two partitions based on the control result of the PDP. When a predetermined condition is satisfied, the PEP forces the SK to use the dynamic policy instead of a part of the static policy.

### CROSS REFERENCE TO RELATED APPLICATION

The present application is based on and claims priority of Japanese Patent Application No. 2024-165014 filed on Sep. 24, 2024.

### FIELD

The present disclosure relates to a control apparatus and a control method.

### BACKGROUND

A security system for monitoring communication access within a vehicle is known (for example, see Patent Literature (PTL) 1). The integration of a vehicle architecture applied to such a security system is shifting from a conventional gateway architecture to a domain architecture and then to a zone architecture centered on high-performance computers. The integration of the vehicle architecture enhances cooperation between systems within the vehicle, thereby enabling more advanced functions to be implemented.

With the development of the connected, autonomous, shared, and electric (CASE) technology, the concept of a software-defined vehicle (SDV), in which vehicle functions are defined by software, is expanding. This makes it possible to add and change vehicle functions by updating software even after a user purchases a vehicle.

### CITATION LIST

### Patent Literature

PTL 1: Japanese Unexamined Patent Application Publication (Translation of PCT Application) No. 2006-521724

### SUMMARY

However, the above-described related art can be improved upon.

Therefore, the present disclosure provides a control apparatus and a control method capable of further improving upon the above related art.

A control apparatus according to one aspect of the present disclosure is a control apparatus provided in a vehicle system logically divided into a plurality of areas, the control apparatus including: a first access controller that controls, based on a static policy, communication access between two areas among the plurality of areas; a determiner that controls the communication access between the two areas based on a dynamic policy; and a second access controller that controls the communication access between the two areas based on a control result of the determiner. When a predetermined condition is satisfied, the second access controller forces the first access controller to use the dynamic policy by replacing a part of the static policy.

Note that the above comprehensive or specific aspect may be implemented by a system, method, integrated circuit, computer program, or recording medium such as a computer-readable compact disc read-only memory (CD-ROM), or by any combination of the system, method, integrated circuit, computer program, and recording medium.

The control apparatus or the like in one aspect of the present disclosure is capable of further improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of a vehicle system according to an embodiment.

FIG. 2 is a block diagram illustrating a configuration of a control apparatus according to the embodiment.

FIG. 3 is a diagram for explaining the operation of the control apparatus according to the embodiment.

FIG. 4 is a flowchart illustrating the operation flow of the control apparatus according to the embodiment.

### DESCRIPTION OF EMBODIMENT

### (Underlying Knowledge Forming Basis of the Present Disclosure)

The present inventors found that the technique described in “Background” section has a problem indicated below.

In the above-described related art, with the integration of the vehicle architecture, the number of attack points and attack paths (so-called attack surfaces) that could be targeted by external attacks increases, creating a demand for implementation of a security architecture that enables improved security.

In order to solve such a problem, the present inventors devised a control apparatus and a control method as indicated below.

### (Technique 1)

A control apparatus provided in a vehicle system logically divided into a plurality of areas, the control apparatus including: a first access controller that controls, based on a static policy, communication access between two areas among the plurality of areas; a determiner that controls the communication access between the two areas based on a dynamic policy; and a second access controller that controls the communication access between the two areas based on a control result of the determiner. When a predetermined condition is satisfied, the second access controller forces the first access controller to use the dynamic policy by replacing a part of the static policy.

According to technique 1, the second access controller forces the first access controller to use the dynamic policy by replacing a part of the static policy only when a predetermined condition is satisfied. That is, strict policy management in the first access controller is relaxed by flexible policy management in the determiner and the second access controller, and the lack of real-time performance in the determiner and the second access controller is compensated by real-time performance in the first access controller. As a result, communication access between two areas can be flexibly controlled in response to a change in vehicle status or the like, and real-time performance can be ensured. As a result, security can be improved.

### (Technique 2)

The control apparatus according to technique 1, wherein the first access controller further controls, based on the static policy, communication access by a component in a specific area among the plurality of areas to a resource in the specific area, the determiner further controls, based on the dynamic policy, the communication access by the component in the specific area to the resource in the specific area, and the second access controller further controls, based on a control result of the determiner, the communication access by the component in the specific are to the resource in the specific area.

According to technique 2, communication access in a specific area can be flexibly controlled in response to a change in vehicle status or the like, and real-time performance can be ensured. As a result, security can be improved.

### (Technique 3)

The control apparatus according to technique 1 or 2, further including: a plurality of devices included in the plurality of areas, wherein the second access controller authenticates an identity of an area or a device that is a request source for the communication access, the area being one of the plurality of areas, the device being one of the plurality of devices, and the determiner controls the communication access between the two areas based on the dynamic policy, ** in consideration of an authentication result of the identity of the request source for the communication access.

According to technique 3, the identity of a request source for communication access is authenticated, thereby enabling further improvement in security.

### (Technique 4)

The control apparatus according to technique 3, wherein a private key or a common key is assigned to each of the plurality of areas or each of the plurality of devices, the private key being different in each of the plurality of areas or each of the plurality of devices, and the second access controller has the common key or a public key that corresponds to the private key for the area or the device corresponding to the second access controller, and authenticates the identity of the request source for the communication access by using the common key or the public key.

According to technique 4, the identity of a request source for communication access is authenticated using a public key or a common key, thereby enabling further improvement in security.

### (Technique 5)

The control apparatus according to technique 3, wherein the second access controller further authenticates an identity of each of areas on a communication access path from an area that is a communication source for the communication access to an area that is a request destination for the communication access. According to technique 5, authentication is performed on the identity of each of areas on a communication access path from an area that is a communication source for the communication access to an area that is a request destination for the communication access, whereby authentication can be layered and security can be further improved.

### (Technique 6)

The control apparatus according to any one of techniques 1 to 5, wherein the determiner obtains vehicle status information related to a status of a vehicle in which the vehicle system is provided, and controls the communication access between the two areas based on the dynamic policy in consideration of the vehicle status information obtained.

According to technique 6, communication access between two areas can be flexibly controlled in accordance with a vehicle status indicated by vehicle status information.

### (Technique 7)

The control apparatus according to technique 6, wherein the determiner changes the dynamic policy in accordance with the status of the vehicle indicated by the vehicle status information.

According to technique 7, communication access between two areas can be flexibly controlled in accordance with a vehicle status indicated by vehicle status information.

### (Technique 8)

The control apparatus according to any one of techniques 1 to 7, wherein the determiner obtains detection information indicating that an attack on the control apparatus has been detected, and changes the dynamic policy based on the detection information.

According to technique 8, communication access between two areas can be flexibly controlled in response to a detection result of an attack on the control apparatus.

### (Technique 9)

The control apparatus according to technique 8, wherein, when the detection information indicates that an attack on the second access controller has been detected, the determiner invalidates the dynamic policy and stops the second access controller from performing control.

According to technique 9, when the second access controller becomes compromised, only the static policy used by the first access controller is applied, whereby communication access between two areas can be reliably controlled.

### (Technique 10)

The control apparatus according to any one of techniques 1 to 9, wherein the first access controller controls communication access related to a task that requires real-time performance, and the second access controller controls communication access related to a task that does not require real-time performance.

According to technique 10, real-time performance of communication access control can be ensured.

### (Technique 11)

The control apparatus according to technique 10, wherein, based on a priority indicating a degree of real-time performance required, the first access controller preferentially controls communication access related to a task having the priority set to a high level.

According to technique 11, real-time performance of communication access control can be ensured.

### (Technique 12)

The control apparatus according to any one of techniques 1 to 11, wherein the second access controller caches an evaluation result of the determiner as to whether communication access requested conforms to the dynamic policy, and upon a request for communication access, (i) when an evaluation result matching the communication access requested has been cached, the second access controller controls the communication access based on the evaluation result cached, and (ii) when an evaluation result matching the communication access requested has not been cached, the second access controller queries the determiner as to whether the communication access requested conforms to the dynamic policy.

According to technique 12, the time for evaluation by the determiner can be shortened.

### (Technique 13)

The control apparatus according to any one of techniques 1 to 12, wherein, when the control apparatus is started, the second access controller calculates and caches an evaluation result of the determiner related to a policy item of the dynamic policy, the policy item having a high usage frequency.

According to technique 13, the time for evaluation by the determiner can be shortened.

### (Technique 14)

The control apparatus according to technique 12 or 13, wherein the second access controller adds a digital signature or a message authentication code (MAC) to an evaluation result to be cached.

According to technique 14, cache integrity can be ensured.

### (Technique 15)

The control apparatus according to any one of techniques 1 to 14, further including: a plurality of second access controllers each of which is the second access controller, wherein the plurality of the second access controllers are respectively disposed in the plurality of areas and are communicable with the determiner.

According to technique 15, by distributing and disposing the second access controllers for the respective areas, the processing load of each of the second access controllers can be reduced. As a result, real-time performance of communication access control can be ensured. can be ensured.

### (Technique 16)

The control apparatus according to technique 15, wherein the determiner includes a master determiner and a plurality of edge determiners, the master determiner and the plurality of edge determiners are each disposed in a corresponding area among the plurality of areas and communicable with a corresponding second access controller among the plurality of second access controllers, and the master determiner is communicable with each of the plurality of edge determiners.

According to technique 16, by distributing and disposing the determiners (the master determiner and the plurality of edge determiners) for the respective areas, the processing load of each of the determiners can be reduced. As a result, real-time performance of communication access control can be ensured. can be ensured.

### (Technique 17)

The control apparatus according to technique 16, wherein each of the plurality of edge determiners transmits to the master determiner an evaluation result as to whether communication access requested conforms to the dynamic policy.

According to technique 17, the evaluation result can be shared between the master determiner and the plurality of edge determiners.

### (Technique 18)

The control apparatus according to technique 17, wherein the master determiner distributes to each of the plurality of edge determiners information necessary for determination based on the dynamic policy as to whether to permit the communication access.

According to technique 18, the information can be shared between the master determiner and the plurality of edge determiners.

### (Technique 19)

The control apparatus according to according to any one of techniques 15 to 18, wherein two or more of the second access controllers are disposed for each of the plurality of areas, the control apparatus further includes a plurality of microcontrollers, and the plurality of second access controllers are disposed to respectively correspond to the plurality of microcontrollers.

According to technique 19, by distributing and disposing the second access controllers for the respective areas, the processing load of each of the second access controllers can be reduced. As a result, real-time performance of communication access control can be ensured. can be ensured.

### (Technique 20)

A control method for a control apparatus provided in a vehicle system logically divided into a plurality of areas, the control method including: (a) controlling, based on a static policy, communication access between two areas among the plurality of areas; (b) controlling the communication access between the two areas based on a dynamic policy; (c) controlling the communication access between the two areas based on a control result of (b); and (d) forcing use of the dynamic policy by replacing a portion of the static policy in (a) when a predetermined condition is satisfied.

According to technique 20, as in technique 1, communication access between two areas can be flexibly controlled in response to a change in vehicle status or the like, and real-time performance can be ensured. As a result, security can be improved.

Note that these comprehensive or specific aspects may be implemented by a system, method, integrated circuit, computer program, or recording medium such as a computer-readable CD-ROM, or by any combination of the system, method, integrated circuit, computer program, or recording medium.

The following embodiment will be specifically described with reference to the drawings.

Note that the embodiment described below shows comprehensive or specific examples. The numerical values, shapes, materials, constituent elements, arrangement positions and connection forms of constituent elements, steps, order of steps, and the like shown in the following embodiment are examples and are not intended to limit the present disclosure. Among the constituent elements in the following embodiment, the constituent elements that are not described in the independent claims indicating the highest-level concepts will be described as optional constituent elements.

### EMBODIMENT

### [1. Assumptions]

A control apparatus according to an embodiment is characterized by a security architecture formed by combining the Multiple Independent Levels of Security (MILS) architecture with the Zero Trust Architecture (ZTA).

Here, prior to the description of the control apparatus according to the embodiment, problems arising when the MILS architecture and the ZTA are independently applied to a vehicle system will be described.

### [1-1. Application of MILS Architecture to Vehicle System]

The MILS architecture is a security concept that assumes that information and processes with different security levels are logically divided.

The main component of the MILS architecture is a separation kernel (SK), and the SK is used to logically divide information and processes with different security levels and manage the divided information and processes without interference with each other.

When the MILS architecture as described above is applied to a vehicle system such as a domain architecture, the following problem arises.

The vehicle system is logically divided into a plurality of partitions with different security levels by the SK. Further, the SK controls communication access between two partitions based on a static policy.

However, the static policy is a predetermined and unchangeable policy, and thus cannot be changed in response to a change in vehicle status (for example, a temporary stop, engine off, charging, or driving on a highway) or the like. This causes a problem with the MILS architecture in that it is difficult to flexibly control communication access between two partitions in response to a change in vehicle status or the like.

### [1-2. Application of ZTA to Vehicle System]

The ZTA is a security concept that assumes that all communication access requests are always verified and authenticated.

The main components of the ZTA are a policy enforcement point (PEP) and a policy decision point (PDP). The PEP is a place where a dynamic policy is implemented, and the PEP receives a communication access request and transmits the received communication access request to the PDP. The PDP verifies the acceptability of the communication access request received from the PDP based on the dynamic policy. Here, the dynamic policy is a changeable policy and can thus be appropriately changed in response to a change in vehicle status or the like.

When the ZTA as described above is applied to a vehicle system such as a domain architecture, the following problem arises.

Since the vehicle status changes every moment, real-time performance is extremely important in vehicle control in the vehicle system. However, in the ZTA, a delay occurs due to the PDP always verifying the acceptability of all communication access requests, which causes a problem in that it is difficult to ensure real-time performance.

### [1-3. Application of MILS Architecture and ZTA to Vehicle System]

In the control apparatus according to the embodiment, the MILS architecture and the ZTA are combined and applied to the vehicle system. That is, strict policy management in the MILS architecture is relaxed by flexible policy management in the ZTA, and the lack of real-time performance in the ZTA is compensated by real-time performance in the MILS architecture.

As a result, communication access between two partitions can be flexibly controlled in response to a change in vehicle status or the like, and real-time performance can be ensured. That is, both of the above-described problems that arise when the MILS architecture and the ZTA are individually applied to the vehicle system can be solved.

### [2. Configuration of Vehicle System]

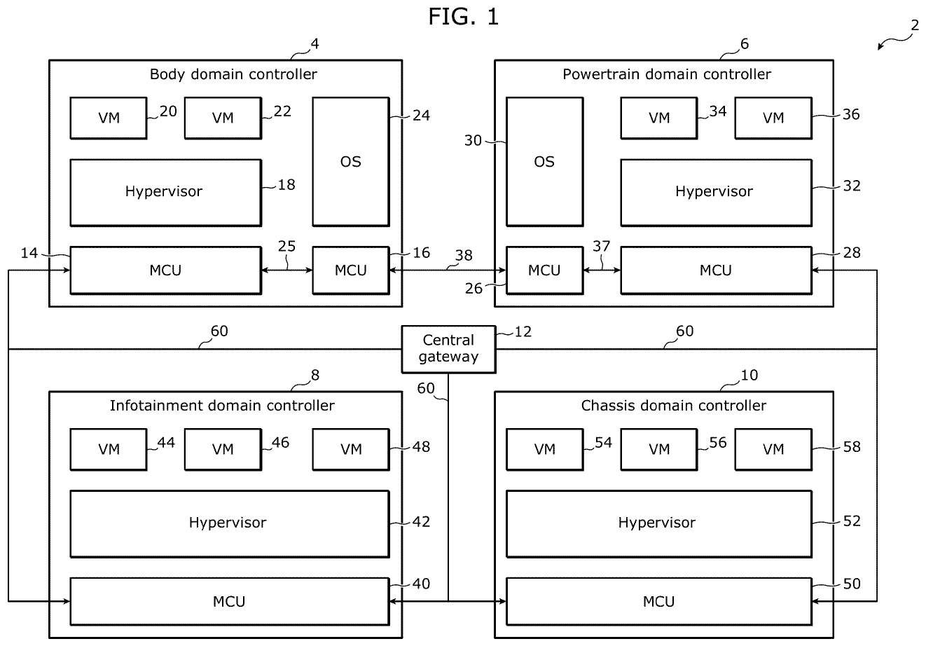

The configuration of vehicle system 2 according to the embodiment will be described with reference to FIG. 1. FIG. 1 is a block diagram illustrating the configuration of vehicle system 2 according to the embodiment.

As illustrated in FIG. 1, vehicle system 2 is formed, for example, of a domain architecture and is provided in a vehicle such as an automobile. Vehicle system 2 includes body domain controller 4, powertrain domain controller 6, infotainment domain controller 8, chassis domain controller 10, and central gateway 12.

Body domain controller 4 is a function-integrated electronic control unit (ECU) for controlling the opening and closing of vehicle windows and the like. Body domain controller 4 includes microcontrollers (MCUs) 14, 16, hypervisor 18, virtual machines (VMs) 20, 22 (an example of a plurality of devices), and operating system (OS) 24.

Microcontrollers 14, 16 are hardware for providing an execution environment for a plurality of computer programs. Note that microcontrollers 14, 16 are communicably connected to each other via serial peripheral interface (SPI) 25.

Hypervisor 18 is virtualization software that is executed on microcontroller 14 and controls the execution of virtual machines 20, 22. This hypervisor 18 enables the plurality of different virtual machines 20, 22 to be virtualized and provided on one microcontroller 14. Note that hypervisor 18 is a so-called Type 1 (bare metal type) hypervisor.

Virtual machines 20, 22 are virtual machines, such as Linux, (registered trademark) that run on hypervisor 18.

Operating system 24 is an operating system that runs on microcontroller 16.

Powertrain domain controller 6 is a function-integrated electronic control unit for controlling the engine and the like of the vehicle. Powertrain domain controller 6 includes microcontrollers 26, 28, operating system 30, hypervisor 32, and virtual machines 34, 36 (an example of the plurality of devices).

Microcontrollers 26, 28 are hardware for providing an execution environment for a plurality of computer programs. Microcontrollers 26, 28 are communicably connected to each other via SPI 37. Note that microcontroller 26 is communicably connected to microcontroller 16 of body domain controller 4 via controller area network (CAN) bus 38.

Operating system 30 is an operating system that runs on microcontroller 26.

Hypervisor 32 is virtualization software that is executed on microcontroller 28 and controls the execution of virtual machines 34, 36. This hypervisor 32 enables a plurality of different virtual machines 34, 36 to be virtualized and provided on one microcontroller 28. Note that hypervisor 32 is a so-called Type1 hypervisor.

Virtual machines 34, 36 are virtual machines, such as Linux, that run on hypervisor 32.

Infotainment domain controller 8 is a function-integrated electronic control unit for controlling a communication module that wirelessly connects the vehicle with a communication network such as the Internet. Infotainment domain controller 8 includes microcontroller 40, hypervisor 42, and virtual machines 44, 46, 48 (an example of the plurality of devices).

Microcontroller 40 is hardware for providing an execution environment for a plurality of computer programs.

Hypervisor 42 is virtualization software that is executed on microcontroller 40 and controls the execution of virtual machines 44, 46, 48. This hypervisor 42 enables a plurality of different virtual machines 44, 46, 48 to be virtualized and provided on one microcontroller 40. Note that hypervisor 42 is a so-called Type1 hypervisor.

Virtual machines 44, 46, 48 are virtual machines, such as Linux, that run on hypervisor 42.

Chassis domain controller 10 is a function-integrated electronic control unit for controlling the operation of the brake of the vehicle and the like. Chassis domain controller 10 includes microcontroller 50, hypervisor 52, and virtual machines 54, 56, 58 (an example of the plurality of devices).

Microcontroller 50 is hardware for providing an execution environment for a plurality of computer programs.

Hypervisor 52 is virtualization software that is executed on microcontroller 50 and controls the execution of virtual machines 54, 56, 58. This hypervisor 52 enables the plurality of different virtual machines 54, 56, 58 to be virtualized and provided on one microcontroller 50. Note that hypervisor 52 is a so-called Type1 hypervisor.

Virtual machines 54, 56, 58 are virtual machines, such as Linux, that run on hypervisor 52.

Microcontroller 14 of body domain controller 4, domain controller 6, microcontroller 28 of powertrain microcontroller 40 of infotainment domain controller 8, and microcontroller 50 of chassis domain controller 10 are communicably connected to central gateway 12 via Ethernet (registered trademark) 60.

### [3. Configuration of Control Apparatus]

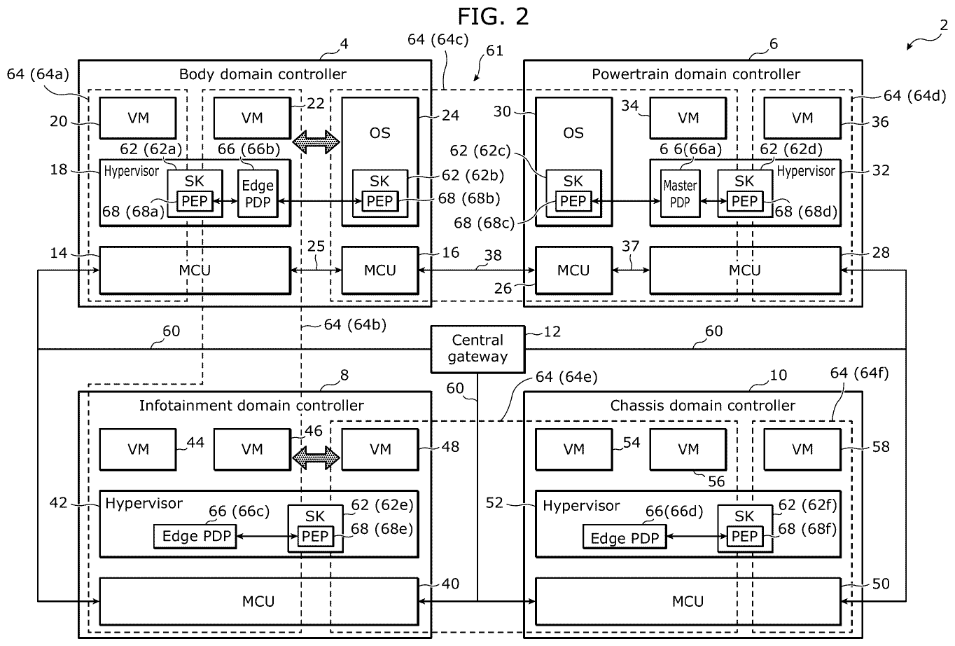

Next, the configuration of control apparatus 61 according to the embodiment will be described with reference to FIG. 2. FIG. 2 is a block diagram illustrating the configuration of control apparatus 61 according to the embodiment.

As illustrated in FIG. 2, control apparatus 61 is a security architecture formed by combining the MILS architecture with the ZTA, and is provided in vehicle system 2 described above.

Control apparatus 61 includes a plurality of SKs 62 (62a, 62b, 62c, 62d, 62e, 62f) (examples of a first access controller) as components of the MILS architecture. As static policy in the MILS architecture, SK 62 has: (i) a static partition separation policy; (ii) a non-changeable static access control policy; and (iii) a changeable static access control policy.

Here, the static policy is a predetermined policy that is, in principle, not changeable. In other words, the static policy is not changeable, but as an exception, only a part of the static policy (changeable static access control policy) is changeable when a predetermined condition, which will be described later, is satisfied. Note that the static policy is expressed in a format that can be understood by PDP 66, which will be described later.

Among the static policies, the static partition separation policy is a policy for logically dividing vehicle system 2 into a plurality of partitions 64 (64a, 64b, 64c, 64d, 64e, 64f) (an example of a plurality of areas) with different security levels. In FIG. 2, the plurality of partitions 64 are indicated by dashed lines.

Among the static policies, the non-changeable static access control policy and the changeable static access control policy are policies defined for: (a) which component in partition 64 can access which resource in same partition 64; and (b) from which partition 64 to which partition 64 communication access is permitted. That is, among the static policies, the non-changeable static access control policy and the changeable static access control policy are policies defined for communication access to all resources in each partition 64.

Based on the static policy (static partition separation policy), SK 62 logically divides vehicle system 2 into a plurality of partitions 64 with different security levels (that is, different policies). SK 62 appropriately allocates resources such as a central processing unit (CPU), memory, and input/output (I/O) to each of the plurality of partitions 64.

Partition 64a includes a part of body domain controller 4. Partition 64b includes a part of body domain controller 4 and a part of infotainment domain controller 8. Partition 64c includes a part of body domain controller 4 and a part of powertrain domain controller 6. Partition 64d includes a part of powertrain domain controller 6. Partition 64e includes a part of infotainment domain controller 8 and a part of chassis domain controller 10. Partition 64f includes a part of chassis domain controller 10.

In the present embodiment, communication access is assumed to be possible between partition 64b and partition 64c, and between partition 64b and partition 64e. On the other hand, communication access is assumed not to be possible between partition 64a and partition 64b, between partition 64c and partition 64d, and between partition 64e and partition 64f.

Here, SK 62a is disposed in hypervisor 18 of body domain controller 4 and is disposed to span partition 64a and partition 64b. SK 62b is disposed in operating system 24 of body domain controller 4. SK 62c is disposed in operating system 30 of powertrain domain controller 6. SK 62d is disposed in hypervisor 32 of powertrain domain controller 6 and is disposed to span partition 64c and partition 64d. SK 62e is disposed in hypervisor 42 of infotainment domain controller 8 and is disposed to span between partition 64b and partition 64e. SK 62f is disposed in hypervisor 52 of chassis domain controller 10 and is disposed to span between partition 64e, 64f.

Based on the static policy (non-changeable static access control policy and changeable static access control policy), SK 62 controls communication access between two partitions 64 among the plurality of partitions 64, thereby preventing data leakage, unauthorized access, and the like. Specifically, based on the static policy, SK 62 determines whether to permit the communication access between two partitions 64. When determining that communication access between two partitions 64 is permitted, SK 62 causes the communication access between two partitions 64 to be executed. On the other hand, when determining that the communication access between two partitions 64 is not permitted, SK 62 disconnects the communication access between two partitions 64. Thus, each of the plurality of partitions 64 is isolated so as not to be affected by other partitions 64, and operates independently.

Moreover, based on the static policy (non-changeable static access control policy and changeable static access control policy), SK 62 controls communication access by the component in specific partition 64 among the plurality of partitions 64 to the resource in this specific partition 64. In this case, similarly to the above, SK 62 determines whether to permit the communication access, and controls the communication access based on the determination result.

Control apparatus 61 includes a plurality of PDPs 66 (examples of a determiner) and a plurality of PEPs 68 (68a, 68b, 68c, 68d, 68e, 68f) (examples of a second access controller) as components of the ZTA.

PDP 66 has a dynamic policy. The dynamic policy is a policy that is changeable even after control apparatus 61 is shipped. In response to a query from PEP 68, based on the dynamic policy, PDP 66 determines whether to permit the communication access between two partitions 64 among the plurality of partitions 64 (that is, controls the communication access between two partitions 64). PDP 66 evaluates the context of a communication access request (for example, user role, device state, and communication access timing), and applies an appropriate policy corresponding to the evaluation result from dynamic policies. In response to a query from PEP 68, based on the dynamic policy, PDP 66 determines whether to permit the communication access by the component in specific partition 64 among the plurality of partitions 64 to the resource in this specific partition 64 (that is, controls communication access to the resource in particular partition 64).

The plurality of PDPs 66 include master PDP 66a (an example of a master determiner) and a plurality of edge PDPs 66b, 66c, 66d (examples of an edge determiner). Master PDP 66a and the plurality of edge PDPs 66b, 66c, 66d are each disposed in corresponding partition 64. Specifically, master PDP 66a is disposed in partition 64c (hypervisor 32 of powertrain domain controller 6). Edge PDP 66b is disposed in partition 64b (hypervisor 18 of body domain controller 4). Edge PDP 66c is disposed in partition 64b (hypervisor 42 of infotainment domain controller 8). Edge PDP 66d is disposed in partition 64e (hypervisor 52 of chassis domain controller 10).

Master PDP 66a is communicably connected to each of the plurality of edge PDPs 66b, 66c, 66d. Thus, master PDP 66a shares information with each of the plurality of edge PDPs 66b, 66c, 66d. Specifically, information of entire vehicle system 2 is aggregated in master PDP 66a, and master PDP 66a distributes to each of edge PDPs 66b, 66c, 66d information necessary for determination based on the dynamic policy as to whether to permit the communication access. Each of edge PDPs 66b, 66c, 66d transmits to master PDP 66a an evaluation result as to whether the requested communication access conforms to the dynamic policy. Note that the timing for sharing information between master PDP 66a and each of the plurality of edge PDPs 66b, 66c, 66d may be, for example, any of or a combination of: (a) immediately after information has been obtained; (b) periodically; (c) instantly in the case of information related to an attack; and (d) when the processing amount is a certain amount or less.

PEP 68 is disposed for each SK 62. Specifically, the plurality of PEPs 68a to 68f are disposed in the plurality of SKs 62a to 62f, respectively. Two PEPs 68 are disposed for each of partitions 64b, 64c, 64e, and one PEP 68 is disposed to correspond to each of microcontrollers 14, 16, 26, 28, 40, 50. PEPs 68a, 68b are communicably connected to edge PDP 66b. PEPs 68c, 68d are communicably connected to master PDP 66a. PEP 68e is communicably connected to edge PDP 66c. PEP 68f is communicably connected to edge PDP 66d.

This extends the function of SK 62, so that SK 62 has the function of PEP 68 in the ZTA as well as the function of SK 62 in the MILS architecture.

When a request for communication access between two partitions 64 among the plurality of partitions 64 occurs, PEP 68 queries PDP 66 as to whether to permit this communication access. PEP 68 controls the communication access between two partitions 64 based on the determination result (control result) of PDP 66, thereby preventing data leakage, unauthorized access, and the like. When PDP 66 determines that the communication access between two partitions 64 is permitted, PEP 68 causes the communication access between two partitions 64 to be executed. On the other hand, when PDP 66 determines that the communication access between two partitions 64 is not permitted, PEP 68 disconnects the communication access between two partitions 64.

Based on the determination result of PDP 66, PEP 68 controls the communication access by the component in specific partition 64 among the plurality of partitions 64 to the resource in this specific partition 64. In this case, similarly to the above, PEP 68 queries PDP 66 as to whether to permit the communication access, and controls the communication access based on the determination result of PDP 66.

PEP 68 is assigned communication access related to a task that does not require real-time performance, while SK 62 described above is assigned communication access related to a task that requires real-time performance. Thus, PEP 68 controls communication access related to a task that does not require real-time performance, while SK 62 described above controls communication access related to a task that requires real-time performance. Note that SK 62 may preferentially control communication access related to a high-priority task based on the priority indicating the degree of real-time performance required.

PEP 68 monitors and logs each communication access. These are used by control apparatus 61 to detect and respond to a security incident.

Moreover, PEP 68 forces SK 62 to use the dynamic policy by replacing a part of the static policy (changeable static access control policy) only when a predetermined condition is satisfied. Note that PEP 68 obtains vehicle status information related to a vehicle status (temporary stop, engine off, charging, driving on expressway, or the like), and determines whether a predetermined condition is satisfied based on the vehicle status indicated by the obtained vehicle status information. Three use cases (use cases 1 to 3) for enforcing the dynamic policy will be described below.

First, use case 1 will be described. In use case 1, software for checking a charging status of a vehicle battery with a smartphone is provided in vehicle system 2, and the vehicle battery is charged in powertrain domain controller 6.

In the static policy (non-changeable static access control policy), communication access from partition 64b to partition 64c is prohibited, and periodic transmission of remaining battery power from partition 64c to partition 64b is permitted.

In the dynamic policy, communication access related to a request to obtain information indicating the charging status from partition 64b to partition 64c is permitted under the condition that vehicle system 2 is in a state of being connected with an electric vehicle (EV) charger and being charged.

Therefore, only when the predetermined condition that vehicle system 2 is in the state of being connected with the EV charger and being charged is satisfied, PEP 68 forces SK 62 to use the dynamic policy: “communication access related to a request to obtain information indicating the charging status from partition 64b to partition 64c is permitted”, by replacing the static policy: “communication access from partition 64b to partition 64c is prohibited”.

Next, use case 2 will be described. In use case 2, the maintenance of vehicle system 2 is performed in body domain controller 4.

In the static policy (non-changeable static access control policy), communication access from partition 64b to partition 64e is prohibited.

In the dynamic policy, transmission of a maintenance command from partition 64b to partition 64e is permitted under the condition that vehicle system 2 is in a state of being connected with a maintenance tool and undergoing maintenance, and that the vehicle is stopped.

Therefore, only when the predetermined condition that vehicle system 2 is in the state of being connected with the maintenance tool and undergoing maintenance, and that the vehicle is stopped, is satisfied, PEP 68 forces SK 62 to use the dynamic policy: “transmission of a maintenance command from partition 64b to partition 64e is permitted”, by replacing the static policy: “communication access from partition 64b to partition 64e is prohibited”.

Next, use case 3 will be described. In use case 3, when intrusion of an attacker is detected in partition 64b, communication access from partition 64b to other partitions 64c, 64e is prohibited as the dynamic policy.

At this time, even if the predetermined conditions described in use cases 1 and 2 are satisfied, the dynamic policies of use cases 1 and 2 are not enforced, and the dynamic policy of use case 3 takes precedence.

Further, for a resource request in partition 64b, additional authentication is performed beyond the normal authentication. For example, integrity verification of the process to be authenticated is performed.

### [4. Operation of Control Apparatus]

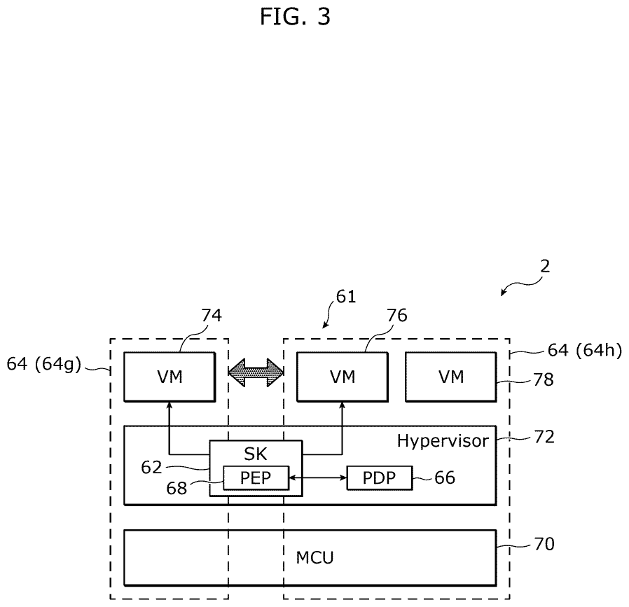

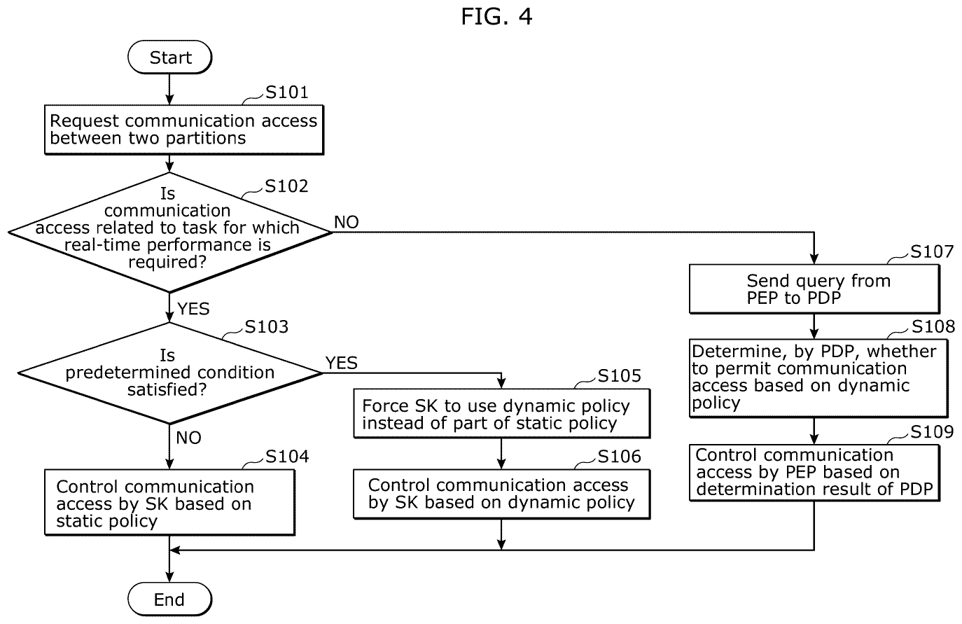

Next, the operation of control apparatus 61 according to the embodiment will be described with reference to FIGS. 3 and 4. FIG. 3 is a diagram for explaining the operation of control apparatus 61 according to the embodiment. FIG. 4 is a flowchart illustrating the flow of the operation of control apparatus 61 according to the embodiment.

Hereinafter, for the sake of clarity, it is assumed that vehicle system 2 includes microcontroller 70, hypervisor 72, and virtual machines 74, 76, 78, as illustrated in FIG. 3. Vehicle system 2 is logically divided into two partitions 64 (64g, 64h) with different security levels by SK 62 of control apparatus 61. SK 62, PDP 66, and PEP 68 of control apparatus 61 are disposed in hypervisor 72.

As illustrated in FIG. 4, a request for communication access between two partitions 64g, 64h occurs (S101). For example, a request for communication access from virtual machine 74 included in partition 64g to virtual machine 76 included in partition 64h occurs.

When the communication access is related to a task that requires real-time performance (YES in S102) and a predetermined condition is not satisfied (NO in S103), SK 62 controls the communication access between two partitions 64g, 64h based on the static policy (S104).

On the other hand, when the communication access is related to a task that requires real-time performance (YES in S102) and the predetermined condition is satisfied (YES in S103), PEP 68 forces SK 62 to use the dynamic policy by replacing a part of the static policy (changeable static access control policy) (S105). Accordingly, SK 62 controls the communication access between two partitions 64g, 64h based on the dynamic policy enforced by PEP 68 instead of a part of the static policy (S106).

Returning to step S102, when the communication access is not related to a task that requires real-time performance (NO in S102), PEP 68 queries PDP 66 as to whether to permit the communication access (S107).

Next, in response to the query from PEP 68, PDP 66 determines, based on the dynamic policy, whether to permit the communication access between two partitions 64g, 64h (S108).

Next, PEP 68 controls the communication access between two partitions 64g, 64h based on the determination result of PDP 66 (S109).

### [5. Effects]

As described above, control apparatus 61 according to the embodiment is a security architecture formed by combining the MILS architecture with the ZTA and extending SK 62 used by the MILS architecture. Specifically, only when a predetermined condition is satisfied, PEP 68 forces SK 62 to use the dynamic policy of the MILS architecture by replacing a part of the static policy of the ZTA.

That is, in control apparatus 61, strict policy management in the MILS architecture is relaxed by flexible policy management in the ZTA, and the lack of real-time performance in the ZTA is compensated by real-time performance in the MILS architecture. As a result, communication access between two partitions 64 can be flexibly controlled in response to a change in vehicle status or the like, and real-time performance can be ensured. Therefore, for example, even if software is updated by the SDV described in the section of Background Art to add or change a function of the vehicle, adaptation to the updated software can be easily achieved.

As a result, a security architecture capable of improving security can be implemented.

### [6. Variations]

Variations of control apparatus 61 according to the embodiment will be described below.

### [6-1. Variation 1]

PEP 68 may authenticate the identity of partition 64 or a virtual machine that is a request source for communication access. In this case, PDP 66 may determine, based on the dynamic policy, whether to permit the communication access between two partitions 64, in consideration of the authentication result of the identity of the request source for the communication access. This enables further improvement in security.

In addition, a different private key or a common key may be assigned to each of the plurality of partitions 64 or each of the plurality of virtual machines. In this case, PEP 68 may have the common key or a public key that corresponds to the private key for partition 64 or the virtual machine corresponding to PEP 68, and may authenticate the identity of the request source for the communication access by using the common key or the public key.

PEP 68 may authenticate the identity of each partition 64 on a communication access path from partition 64, which is the communication source for the communication access, to partition 64, which is the request destination for the communication access (for example, partition 64c→partition 64b→partition 64e).

### [6-2. Variation 2]

PDP 66 may obtain vehicle status information related to the vehicle status and determine, based on the dynamic policy in consideration of the obtained vehicle status information, whether to permit the communication access between two partitions 64. In this case, PDP 66 may appropriately change the dynamic policy in accordance with a change in vehicle indicated by the vehicle status information.

Accordingly, the communication access between two partitions 64 can be flexibly controlled in accordance with the vehicle status indicated by the vehicle status information.

### [6-3. Variation 3]

PDP 66 may obtain detection information indicating that an attack on control apparatus 61 has been detected, and may appropriately change the dynamic policy based on the detection information.

Alternatively, when the detection information indicates that an attack on PEP 68 has been detected, PDP 66 may invalidate the dynamic policy and stop the control of PEP 68. Thus, when PEP 68 becomes compromised, only the static policy used by SK 62 is applied, so that communication access between two partitions 64 can be reliably controlled. In this case, PEP 68 for backup may be prepared in advance, and compromised PEP 68 may be quickly switched to PEP 68 for backup. This enables early recovery of application of the dynamic policy.

### [6-4. Variation 4]

PEP 68 may cache an evaluation result of PDP 66 as to whether the requested communication access conforms to the dynamic policy. Upon a request for communication access, (i) when an evaluation result matching the requested communication access is cached, PEP 68 may control the communication access based on the cached evaluation result, and (ii) when an evaluation result matching the requested communication access is not cached, PEP 68 may query PDP 66 as to whether the requested communication access conforms to the dynamic policy. Accordingly, the time for evaluation by PDP 66 can be shortened.

When control apparatus 61 is started, PEP 68 may calculate and cache an evaluation result of PDP 66 related to a policy item, included in the dynamic policy, having a high usage frequency.

PEP 68 may add a digital signature or a message authentication code (MAC) to an evaluation result to be cached.

### (Other Variations)

The control apparatuses according to one or more aspects have been described based on the above embodiment, but the present disclosure is not limited to the above embodiment. As long as the gist of the present disclosure is not deviated from, the one or more aspects may include forms in which various modifications conceived by those skilled in the art are applied to the above embodiment, or forms constructed by combining constituent elements in different embodiments.

In the above embodiment, the plurality of PDPs 66 have been arranged in vehicle system 2, but the present disclosure is not limited thereto, and only one PDP 66 may be disposed in vehicle system 2.

Alternatively, one edge PDP may be disposed for each partition or domain controller, and information may be synchronized between each edge PDP and the master PDP. Alternatively, the plurality of PDPs 66 may be formed entirely of edge PDPs, and the master PDP may be omitted. In this case, information is synchronized among the plurality of edge PDPs.

Authentication and authorization for communication access between two partitions 64 may be shared with the following configuration. That is, authentication may be mediated by SK 62 (PEP 68), but the actual authentication processing may be performed by PDP 66. In this case, PDP 66 determines the authority necessary for authorization, and SK 62 (PEP 68) grants the authority.

Alternatively, SK 62 (PEP 68) may perform authentication, and PDP 66 may not be queried about authentication. In this case, PDP 66 determines the authority necessary for authorization, and SK 62 (PEP 68) grants the authority.

Addition of a virtual machine or other components to partition 64, formation of new partition 64, and the like correspond to changes in the static partition separation policy, and thus require modifications in the static policy. In this case, it is necessary to rewrite the static policy through an over-the-air (OTA) update and restart control apparatus 61. This also applies to the static access control policy.

Allocation of resources in partition 64 and addition of communication between two partitions 64 correspond to changes in the dynamic access control policy, and thus require modifications in the dynamic policy.

In the above embodiment, each constituent element may be configured with dedicated hardware or implemented by executing a computer program suitable for each constituent element. Each constituent element may be implemented by a program executer such as a central processing unit (CPU) or a processor reading and executing a computer program recorded in a recording medium such as a hard disk or a semiconductor memory.

Some or all of the functions of the control apparatus according to the above embodiment may be implemented by a processor such as a CPU executing a computer program.

Some or all of the constituent elements constituting each of the above devices may be formed of an integrated circuit (IC) card or a single module detachable from each of the devices. The IC card or the module is a computer system formed of a microprocessor, read-only memory (ROM), random-access memory (RAM), and the like. The IC card or the module may include an ultra-multifunctional large-scale integrated circuit (LSI). The microprocessor operates in accordance with the computer program, whereby the IC card or the module achieves its function. The IC card or the module may be tamper-resistant.

The present disclosure may be the method described above. The present disclosure may be a computer program that causes a computer to implement the method, or a digital signal including the computer program. The present disclosure may be a computer program or a digital signal recorded on a computer-readable non-temporary recording medium, such as a flexible disk, a hard disk, a CD-ROM, a magneto-optical disk (MO), a digital versatile disc (DVD), a DVD-ROM, a DVD-RAM, a Blu-ray disc (BD) (registered trademark), a semiconductor memory, or the like. The present disclosure may be a digital signal recorded on the above recording medium. The present disclosure may be implemented by transmitting a computer program or a digital signal via a telecommunication line, a wireless or wired communication line, a network represented by the Internet, a data broadcast, or the like. The present disclosure may be a computer system including a microprocessor and memory, the memory may store the computer program, and the microprocessor may operate in accordance with the computer program. The present disclosure may be implemented by another independent computer system by recording and transferring the computer program or the digital signal on the recording medium, or by transferring the computer program or the digital signal via the network or the like.

Further Information about Technical Background to this Application

The disclosure of the following patent application including specification, drawings, and claims is incorporated herein by reference in their entirety: Japanese Patent Application No. 2024-165014 filed on Sep. 24, 2024.

### INDUSTRIAL APPLICABILITY

The control apparatus according to the present disclosure can be provided, for example, in a vehicle system such as a domain architecture.

1. A control apparatus provided in a vehicle system logically divided into a plurality of areas, the control apparatus comprising:
a first access controller that controls, based on a static policy, communication access between two areas among the plurality of areas;
a determiner that controls the communication access between the two areas based on a dynamic policy; and
a second access controller that controls the communication access between the two areas based on a control result of the determiner,
wherein when a predetermined condition is satisfied, the second access controller forces the first access controller to use the dynamic policy by replacing a part of the static policy.

2. The control apparatus according to claim 1,
wherein the first access controller further controls, based on the static policy, communication access by a component in a specific area among the plurality of areas to a resource in the specific area,
the determiner further controls, based on the dynamic policy, the communication access by the component in the specific area to the resource in the specific area, and
the second access controller further controls, based on a control result of the determiner, the communication access by the component in the specific area to the resource in the specific area.

3. The control apparatus according to claim 1, further comprising:
a plurality of devices included in the plurality of areas,
wherein the second access controller authenticates an identity of an area or a device that is a request source for the communication access, the area being one of the plurality of areas, the device being one of the plurality of devices, and
the determiner controls the communication access between the two areas based on the dynamic policy, in consideration of an authentication result of the identity of the request source for the communication access.

4. The control apparatus according to claim 3,
wherein a private key or a common key is assigned to each of the plurality of areas or each of the plurality of devices, the private key being different in each of the plurality of areas or each of the plurality of devices, and
the second access controller has the common key or a public key that corresponds to the private key for the area or the device corresponding to the second access controller, and authenticates the identity of the request source for the communication access by using the common key or the public key.

5. The control apparatus according to claim 3,
wherein the second access controller authenticates an identity of each of areas on a communication access path from an area that is a communication source for the communication access to an area that is a request destination for the communication access.

6. The control apparatus according to claim 1,
wherein the determiner obtains vehicle status information related to a status of a vehicle in which the vehicle system is provided, and controls the communication access between the two areas based on the dynamic policy in consideration of the vehicle status information obtained.

7. The control apparatus according to claim 6,
wherein the determiner changes the dynamic policy in accordance with the status of the vehicle indicated by the vehicle status information.

8. The control apparatus according to claim 1,
wherein the determiner obtains detection information indicating that an attack on the control apparatus has been detected, and changes the dynamic policy based on the detection information.

9. The control apparatus according to claim 8,
wherein, when the detection information indicates that an attack on the second access controller has been detected, the determiner invalidates the dynamic policy and stops the second access controller from performing control.

10. The control apparatus according to claim 1,
wherein the first access controller controls communication access related to a task that requires real-time performance, and
the second access controller controls communication access related to a task that does not require real-time performance.

11. The control apparatus according to claim 10,
wherein, based on a priority indicating a degree of real-time performance required, the first access controller preferentially controls communication access related to a task having the priority set to a high level.

12. The control apparatus according to claim 1,
wherein the second access controller caches an evaluation result of the determiner as to whether communication access requested conforms to the dynamic policy, and
upon a request for communication access,
(i) when an evaluation result matching the communication access requested has been cached, the second access controller controls the communication access based on the evaluation result cached, and
(ii) when an evaluation result matching the communication access requested has not been cached, the second access controller queries the determiner as to whether the communication access requested conforms to the dynamic policy.

13. The control apparatus according to claim 1,
wherein, when the control apparatus is started, the second access controller calculates and caches an evaluation result of the determiner related to a policy item of the dynamic policy, the policy item having a high usage frequency.

14. The control apparatus according to claim 12,
wherein the second access controller adds a digital signature or a message authentication code (MAC) to an evaluation result to be cached.

15. The control apparatus according to claim 1, further comprising:
a plurality of second access controllers each of which is the second access controller,
wherein the plurality of the second access controllers are respectively disposed in the plurality of areas and are communicable with the determiner.

16. The control apparatus according to claim 15,
wherein the determiner includes a master determiner and a plurality of edge determiners,
the master determiner and the plurality of edge determiners are each disposed in a corresponding area among the plurality of areas and communicable with a corresponding second access controller among the plurality of second access controllers, and
the master determiner is communicable with each of the plurality of edge determiners.

17. The control apparatus according to claim 16,
wherein each of the plurality of edge determiners transmits to the master determiner an evaluation result as to whether communication access requested conforms to the dynamic policy.

18. The control apparatus according to claim 17,
wherein the master determiner distributes to each of the plurality of edge determiners information necessary for determination based on the dynamic policy as to whether to permit the communication access.

19. The control apparatus according to claim 15,
wherein two or more of the second access controllers are disposed for each of the plurality of areas,
the control apparatus further comprises a plurality of microcontrollers, and
the plurality of second access controllers are disposed to respectively correspond to the plurality of microcontrollers.

20. A control method for a control apparatus provided in a vehicle system logically divided into a plurality of areas, the control method comprising:
(a) controlling, based on a static policy, communication access between two areas among the plurality of areas;
(b) controlling the communication access between the two areas based on a dynamic policy;
(c) controlling the communication access between the two areas based on a control result of (b); and
(d) forcing use of the dynamic policy by replacing a portion of the static policy in (a) when a predetermined condition is satisfied.
